(19) United States
(12) Patent Application Publication
(10) Pub. No.: US 2010/0144229 A1
(43) Pub. Date: Jun. 10, 2010

(54) Fabrication line of electrophoretic display device and method of fabricating electrophoretic display device

(76) Inventor: ChangHoon Lee, Gyeongsangbuk-Do (KR)

Correspondence Address: MCKENNA LONG & ALDRIDGE LLP, 1900 K STREET, NW, WASHINGTON, DC, 20006, US

(21) Appl. No.: 12/654,040

(22) Filed: Dec. 8, 2009

(30) Foreign Application Priority Data
Dec. 9, 2008 (KR) 10-2008-0124941

(51) Int. Cl. H01J 9/26; B32B 38/00; B32B 41/00; H01J 9/42

(52) U.S. Cl. 445/3; 156/390; 156/362; 445/25

(57) ABSTRACT

The present invention is provided to automate an overall fabrication line by performing an adhesion of a FPL film and a protection film in a mother substrate unit, and the FPL film and protection film may be adhered to each of a plurality of panel regions on a mother substrate formed with a plurality of thin-film transistors and various wirings in a thin-film transistor array process, and a cutting of the mother substrate may be performed subsequent to adhering the FPL film and the protection film.

### CROSS-REFERENCE TO RELATED APPLICATIONS

Pursuant to 35 U.S.C. §119(a), this application claims the benefit of earlier filing date and right of priority to Korean Application No. 10-2008-0124941 filed on Dec. 9, 2008, the contents of which are incorporated by reference for all purposes as if fully set forth herein.

### BACKGROUND OF THE INVENTION

1. Field of the Invention

The present invention relates to a fabrication line and fabrication method of an electrophoretic display device, and more particularly, to a fabrication line and fabrication method of an electrophoretic display device in which a FPL film and a protection film are adhered in a mother substrate unit, thereby automating an overall fabrication line thereof.

2. Description of the Related Art

In general, an electrophoretic display device is an image display device using a phenomenon that colloidal particles move to either one of the polarities when one pair of electrodes to which a voltage is applied are immersed into a colloidal solution. The electrophoretic display device in which a backlight is not used, but having characteristics such as wide viewing angle, high reflectivity, low power consumption, and the like, and thus it is widely used as an electronic device such as electronic paper.

The electrophoretic display device has a structure, in which an electronic ink layer is interposed between two substrates, and at least one of the two substrates is made of a transparent substrate and the other substrate is provided with a reflection plate to display images in a reflective mode in which incident light is reflected.

FIG. 1 is a cross-sectional view illustrating a typical electrophoretic display device. In actuality, a plurality of pixels defined by a plurality of gate lines and data lines arranged vertically and horizontally to receive signals from the outside are arranged in an electrophoretic display device, but in the drawing, it is shown only one pixel for the sake of convenience of explanation.

As illustrated in FIG. 1, an electrophoretic display device 1 includes a first substrate 20 and a second substrate 30, and the first substrate 20 is a substrate made of glass, or the like, and the second substrate 30 is made of a transparent sheet such as a flexible PET.

A thin-film transistor and a pixel electrode 18 are formed on the first substrate 20, and a signal is applied to the pixel electrode 18 through the thin-film transistor from the outside. The thin-film transistor includes a gate electrode 10 formed on the first substrate 20, a gate insulation substrate 22 formed over the overall first substrate 20 that is formed with the gate electrode 10, a semiconductor layer 12 formed on the gate insulation substrate 22, and a source electrode 14 and a drain electrode 15 formed on the semiconductor layer 12. A protection layer 24 is formed on the thin-film transistor, that is, the source electrode 14 and the drain electrode 15.

A pixel electrode 18 is formed on the protection layer 24, and the pixel electrode 18 is electrically connected to a drain electrode 15 of a thin-film transistor through a contact hole formed on the protection layer 24.

A common electrode 32 and an electronic ink layer 40 made of a transparent conductive material are formed on the second substrate 30. The electronic ink layer 40 is in a film shape in which capsules 42 filled with electronic ink in a polymer binder are distributed, and the electronic ink distributed in the capsules 42 consists of white particles (or white ink) 44 and black particles (or black ink) 46. At this time, the white particles 44 and black particles 46 have the characteristics of positive and negative charges, respectively. In other words, the white particles 44 are positively charged, and the black particles 46 are negatively charged.

The common electrode 32 faces the pixel electrode 18 of the first substrate 20, and if a signal is applied to the pixel electrode 18, then an electric field is formed in cooperation with the pixel electrode 18 to apply the electric field to the electronic ink layer 40, and as a result, the white particles 44 and black particles 46 in the capsules 42 are moved by the electric field in order to display an image.

Furthermore, a common line 26 allowing a common signal to be applied from the outside is formed, and an Ag-dotting portion making contact with the common electrode 32 of the second substrate 30 is disposed on the common line 26 to apply a common signal inputted through the common line 26 to the common electrode 32 of the second substrate 30.

The second substrate 30 having the foregoing configuration is adhered to the first substrate 20 and a seal material 29 is provided between the first substrate 20 and the second substrate 30, thereby finishing an electrophoretic display device 1. As described above, a protection film 36 is adhered to the second substrate 30 adhered with the first substrate 20, thereby preventing the defect of water infiltration into the electronic ink layer 40 from being generated.

FIG. 2 is a flow chart illustrating a method of fabricating an electrophoretic display device according to the related art, and referring to the drawing, the method of fabricating an electrophoretic display device in the related art will be described below.

As illustrated in FIG. 2, first, in the TFT array process, thin-film transistors and various wirings and electrodes are formed on each of a plurality of panel regions formed on a mother substrate (S101). At this time, the thin-film transistors and various wirings and electrodes are formed by a typical photolithographic process.

As described above, a mother substrate formed with various elements such as thin-film transistor (T) on a plurality of panel regions is cut into the panel regions by a cutting device to be divided into a plurality of display panels (S102). Then, a silver dot is dotted on the common line in each of the divided display panels (S103).

On the other hand, in the electronic ink layer forming line, a transparent conductive material is laminated on transparent sheets corresponding to the number of panel regions formed on the mother substrate to form a common electrode, and then an electronic ink film is adhered to the common electrode to form a front plane laminate (FPL) film (S105).

The FPL film adhered with an electronic ink film as described above is adhered to each of the divided display panels, and a protection film is adhered to the FPL film, and then a seal material is coated and the seal material is cured to seal the FPL film and protection film, thereby finishing a electrophoretic display device (S106, S107).

However, the foregoing electrophoretic display device has a problem as follows.

The thin-film transistors are formed on a large-sized glass or large-sized metal plate formed with a plurality of panels, whereas the electronic ink layer 40 is formed on a second substrate, i.e., transparent sheet 30 formed in a panel unit.

According to an electrophoretic display device in the related art, the mother substrate is divided into a display panel unit when adhering the second substrate 30 to the first substrate 20 and then the second substrate 30 and the protection film 36 should be adhered to the first substrate 20 on each of the divided display panels. Consequently, a plurality of the first substrates 20 cut in the cutting process are stored in a storage place, and then the second substrate 30 and the protection film 36 should be adhered to each of the divided first substrates 20. However, such a procedure should be performed manually by the operator because it cannot be automated. As a result, in a method of fabricating an electrophoretic display device in the related art, there is a problem that an overall fabrication process cannot be automated, because it is impossible to automate a procedure for storing a plurality of first substrates 20, cut from a mother substrate, and performing subsequent processes on each of the stored first substrates 20.

### SUMMARY OF THE INVENTION

The present invention is contrived to solve the aforementioned problem, and an object of the invention is to provide a fabrication line and fabrication method of an electrophoretic display device in which a transparent film and a protection film are adhered in a motherboard unit, thereby automating an overall fabrication line thereof.

In order to accomplish the foregoing object, a fabrication line of an electrophoretic display device according to the present invention may include a thin-film transistor array line for forming thin-film transistors on a mother substrate formed with a plurality of panel regions; an electronic ink line for forming a common electrode on a transparent sheet and adhering an electronic ink film to form a front plane laminate (FPL) film; an adhesion line for adhering a FPL film to the plurality of panel regions formed on a mother substrate by loading the mother substrate and the FPL film from the thin-film transistor array line and the electronic ink line, respectively; and a protection film adhesion line for adhering a protection film on the plurality of panel regions by loading a mother substrate adhered with a FPL film from the adhesion line, wherein the panel regions are arranged in a matrix with M columns and N rows (M and N are greater than or equal to 2) on the mother substrate, and N or M robot arms are provided to adhere FPL films and protection films to the plurality of panel regions formed on the mother substrate in a column or row unit.

The adhesion line may include an adhesion table being loaded with a mother substrate; at least one camera provided on an upper portion of the adhesion table to align the mother substrate with a FPL film; and at least one robot arm for loading a FPL film on the mother substrate adhered to the adhesion table.

Furthermore, a fabrication method of an electrophoretic display device according to the present invention may include the steps of forming thin-film transistors on a mother substrate formed with a plurality of panel regions; forming a common electrode on a transparent sheet and adhering an electronic ink film to form a front plane laminate (FPL) film; adhering a FPL film to the plurality of panel regions formed on a mother substrate; and adhering a protection film on each of the plurality of panel regions on the mother substrate adhered with the FPL film, wherein the panel regions are arranged in a matrix with M columns and N rows (M and N are greater than or equal to 2) on the mother substrate to adhere FPL films and protection films in a column or row unit.

According to the present invention, an adhesion of a FPL film and a protection film is performed in a mother substrate unit to automate an overall fabrication line, thereby reducing the fabrication cost and drastically reducing the fabrication time. In addition, it may be possible to eliminate an operator's manual work, thereby minimizing the defect thereof.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view illustrating a typical electrophoretic display device;

FIG. 2 is a flow chart illustrating a method of fabricating an electrophoretic display device according to the related art;

FIG. 3 is a flow chart illustrating a fabrication method of an electrophoretic display device according to the present invention;

FIG. 4 is a view illustrating a mother substrate in which a plurality of thin-film transistors are formed by a thin-film transistor array process;

FIG. 5 is a block diagram schematically illustrating a fabrication line of an electrophoretic display device according to the present invention; and

FIG. 6 is a transparent sheet adhesion table according to the present invention.

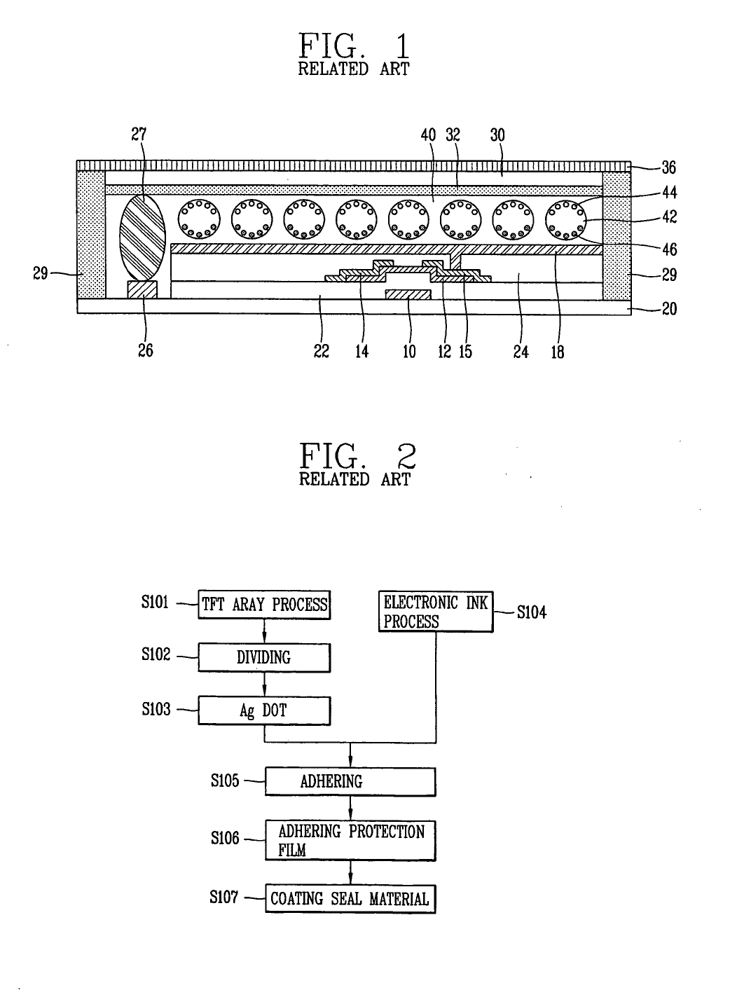

### DETAILED DESCRIPTION OF THE INVENTION

Hereinafter, an electrophoretic display device according to the present invention will be described in detail with reference to the accompanying drawings.

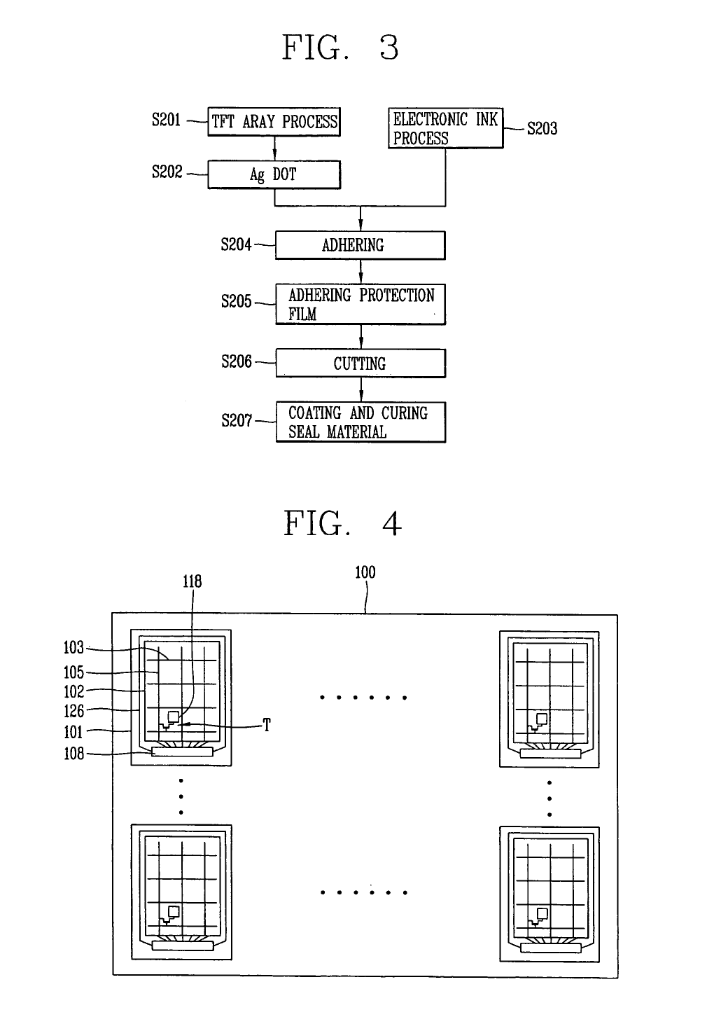

As illustrated in FIG. 3, first, in the TFT array process, thin-film transistors and various wirings and electrodes are formed in each of a plurality of panel regions formed on a mother substrate made of a metal (S201). At this time, a transparent glass substrate or metal plate may be used as the mother substrate. In case of using a metal plate, the metal plate's own property has flexibility and thus it may be possible to fabricate a flexible electrophoretic display device.

In FIG. 4, there is disclosed a structure in which thin-film transistors and the like are formed by a TFT array process in each of the panel regions 101 of a mother substrate. Even though two columns of panel regions 101 are formed in a mother substrate 100 in the drawing, it is not limited to such a structure of the mother substrate 100 according to the present invention. Three columns or more panel regions 101 may be arranged in a mother substrate 100 of the present invention, and the number of such panel regions 101 will not be limited. In other words, one or more panel regions 101 may be arranged in a matrix form in a column or row direction on the mother substrate 100.

As illustrated in FIG. 4, a display panel may be formed by a TFT array process in each of a plurality of panel regions 101. Each of the panel regions 101 is formed with a display region 102 forming a plurality of pixels to implement actual images, a pad 108 connected to an external drive element to apply a signal to the display region 102, and a common line 126 for inputting a common signal from the outside. The display region 102 is formed with a plurality of gate lines 103 and data lines 105 vertically and horizontally arranged for defining a plurality of pixels, a thin-film transistor (T) disposed at each pixel and connected to the gate lines 103 and data lines 105, and a pixel electrode 118 disposed at each pixel.

Though not shown in the drawing, the thin-film transistor (T) may include a gate electrode formed at the mother substrate 100, a gate insulation layer formed on the gate electrode, a semiconductor layer formed on the gate insulation layer, and a source electrode and a drain electrode formed on the semiconductor layer. At this time, the gate lines 103 are formed by the same process as that of the gate electrode of the thin-film transistor (T), and the data lines 105 are formed by the same process as that of the source electrode and drain electrode of the thin-film transistor (T). The pixel electrode 118 is connected to a drain electrode of the thin-film transistor, and a signal inputted through the thin-film transistor is applied to the pixel electrode 118. Furthermore, the common line 126 and pad 108 are formed by the same process as that of the gate electrode or source electrode of the thin-film transistor.

As described above, silver (Ag) is dotted on the common line 126 in each of the panel regions on a first mother substrate formed with thin-film transistors and various wirings and electrodes in a plurality of panel regions (S202).

On the other hand, in the electronic ink line, a transparent conductive material is laminated on the PET and transparent sheet to form a common electrode, and then an electronic ink film is adhered to the common electrode to form a front plane laminate (FPL) film (S203). Subsequently, a plurality of FPL films made of the transparent sheet and the electronic ink film adhered to the transparent sheet are adhered to the corresponding panel regions formed on a mother substrate, respectively (S204). At this time, the FPL films are provided with an adhesion layer, and thus the FPL films are adhered to the panel regions of the mother substrate by the adhesion layer.

Subsequently, protection films are adhered to the plurality of panel regions of the mother substrate adhered with the FPL films, respectively, and then the mother substrate is cut by a cutting device and divided into a plurality of display panels, thereby finishing an electrophoretic display device (S205, S206).

As described above, according to the present invention, all processes from the formation of thin-film transistors to the adhesion of a FPL film and a protection film are performed in a mother substrate unit and the cutting of a mother substrate is performed subsequent to the adhesion of a protection film, and therefore, individual electrophoretic display panels are completed without performing a particular separate process subsequent to the cutting of a mother substrate, thereby automating processes from the thin-film transistor array process to the cutting process.

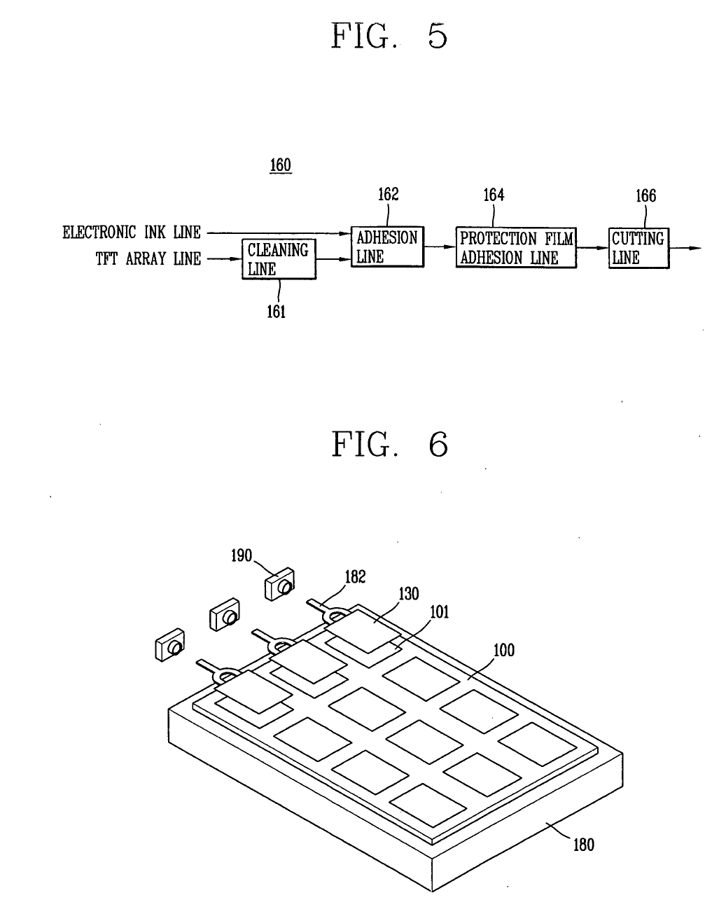

FIG. 5 is a view illustrating a fabrication line of an electrophoretic display device according to the present invention to implement a fabrication method as illustrated in FIG. 3, and an automated and integrated fabrication line is illustrated in the drawing. In other words, the fabrication line as illustrated in FIG. 5 makes an operator's manual work unnecessary during all of the fabrication processes.

As illustrated in FIG. 5, the fabrication line of an electrophoretic display device 160 may include a cleaning line 161 for cleaning a mother substrate formed with a plurality of thin-film transistors and pixel electrodes, and the like, on each of a plurality of panel regions by inputting the mother substrate from the TFT array process, an adhesion line 162 for adhering a plurality of FPL films to the panel regions formed on a mother substrate by loading the cleaned mother substrate from the cleaning line 161 and a FPL film formed with a common electrode and adhered with an electronic ink film on a transparent sheet from the electronic ink line, a protection film adhesion line 164 for adhering a protection film on the FPL films of the plurality of panel regions in a mother substrate adhered with the FPL films that have been inputted from the adhesion line 162, and a cutting line 166 for cutting a mother substrate adhered with the protection film and dividing into unit panels, thereby finishing an electrophoretic display device.

Though not shown in the drawing, different processes are performed in a substantially different environment in each of the process lines. Accordingly, a transfer means for transferring a mother substrate 100, which is a subject of the process, is required between each of the process lines, and a conveyer belt is used as the transfer means in the present invention. The conveyer belt loads a mother substrate 100 by transferring the mother substrate 100 being unloaded from a previous process line to a subsequent process line. Such a conveyer belt is linked with the fabrication lines, thereby allowing processes to be continuously advanced.

Furthermore, though not shown in the drawing, a mother substrate 100 and a FPL film are stored for a preset time respectively, thereby synchronizing between each of the process lines and synchronizing the mother substrate 100 and the FPL film.

The mother substrate 100 that has passed through the TFT array process is cleaned in the cleaning line 161. In the TFT array process, thin-film transistors, various wirings, and the like are formed by etching a metal layer and an insulation layer by a photolithographic process using a photoresist. Therefore, foreign substances such as dregs of the photoresist, dregs of the etched metal, dregs of the etched insulation layer, and the like, remain on the mother substrate 100 that has passed through the TFT array process. Those foreign substances are removed in the cleaning line 161. The mother substrate 100 uses cleaning solution such as deionized water or air. At this time, in case of using deionized water, impurities remaining on the mother substrate 100 may be removed by dispersing the deionized water to the mother substrate 100. Moreover, a fan heater is provided in the cleaning line 161 to evaporate the deionized water that has cleaned the mother substrate 100, thereby preventing moisture from being remained thereon.

In case of using air, foreign substances remaining on the mother substrate 100 may be removed by blowing air to the mother substrate 100.

In the adhesion line 162, thin-film transistors and various wirings are formed on a plurality of panel regions in the TFT array process, and the cleaned mother substrate and a FPL film are loaded from the TFT array process and the electronic ink line, respectively.

FIG. 6 is an adhesion table 180 provided in the adhesion line. As illustrated in FIG. 6, a mother substrate 100 formed with a plurality of panel regions 101 is loaded on the adhesion table 180. At this time, though not shown in the drawing, a plurality of absorption holes connected to an external vacuum device (not shown) are formed in a region to be loaded with the mother substrate 100 in order to absorb the mother substrate as the mother substrate 100 being loaded, thereby fixing the mother substrate 100 to the adhesion table 180.

Furthermore, a camera 190 is provided at an upper portion of the adhesion table 180. The camera 190 aligns a panel region 101 of the mother substrate 100 with a FPL film 130 adhered to the panel region 101, in such a manner that the FPL film 130 is adhered to a predetermined location of the panel region 101 all the time. Though not shown in the drawing, for this alignment, an alignment mark is formed on the mother substrate 100.

One or a plurality of cameras 190 may be arranged. In case of providing a plurality of cameras 190, the cameras 190 may be provided with the number of the panel regions 101 formed on the mother substrate 100 to align all panel regions 101 with the corresponding FPL films 130, or may be provided with the number of the columns or rows of the panel regions 101 to align each column or row of the panel regions 101 with the corresponding FPL films 130. Furthermore, in case of being arranged with one camera 190, the camera 190 is aligned on the panel regions in a mother substrate unit. In other words, a plurality of panel regions is aligned by one camera 190.

If a mother substrate 100 is loaded and fixed to an adhesion table 180 having the foregoing configuration, then a FPL film 130 being adhered to an electronic ink film is loaded to the adhesion table 180. The FPL film 130 is loaded to the corresponding panel region 101 of the mother substrate 100 by a robot arm 182, and then placed on the panel region 101 aligned by the camera 190 and then adhered to the panel region 101.

As illustrated in FIG. 6, the mother substrate 100 is arranged with N×M panel regions 101 (M and N are greater than or equal to 2). The robot arms 182 corresponding to the whole number of the panel regions 101, i.e., N×M, are provided and thus the corresponding FPL films 130 may be adhered to all panel regions 101 at the same time. However, for the cost reduction or the process effectiveness, it may be preferably provided with N or M robot arms 182 in order to adhere the FPL films 130 to the corresponding panel regions 101 in a column or row unit at the same time.

On the other hand, an Ag dot disposed on a common line of the panel region 101 may be formed in the TFT array process, or may be formed in the adhesion table 180. Typically, a mother substrate that has passed through the TFT array process is transferred to the adhesion line by a transfer means such as conveyer. Therefore, impurities or the like may remain on the mother substrate during the transfer process. In case when such impurities remain on the Ag dot, an electrical connection between the first substrate and the second substrate will be blocked, thereby causing a failure.

As a result, when an Ag dot is implemented on the adhesion table 180, the above-mentioned impurities can be suppressed because the mother substrate 100 has been previously cleaned through the cleaning line 161. Furthermore, an Ag dot region is aligned by the camera 190 that is provided on the adhesion table 180 to form an Ag dot, thereby suppressing the failure of the Ag dot.

Here, the formation of the Ag dot on the adhesion table 180 is implemented prior to the FPL film 130 being adhered to the panel regions 101.

Though not shown in the drawing, a protection film adhesion table such as a FPL film adhesion table 180 is also provided in a protection film adhesion line 164. The protection film adhesion table is also configured similarly to the FPL film adhesion table 180, and thus protection films are adhered to the panel regions 101 of the mother substrate 100 arranged in a N×M matrix in a column or row unit by using robot arms (of course, may be adhered individually or at once). At this time, the mother substrate 100 adhered to the FPL film is also transferred from the adhesion line 162 to the protection film adhesion line 164 by a transfer means such as conveyer belt, and then loaded to the protection film adhesion table.

Furthermore, the protection film may be adhered on the adhesion table 180 as illustrated in FIG. 6. In other words, subsequent to finishing an adhesion of the FPL film 130 on the adhesion table 180, a protection film is adhered by loading the protection film by a robot arm in order to place the protection film on a panel region 101 of the mother substrate 100.

In this manner, both the FPL film 130 and the protection film are adhered on an adhesion table 180, and thus it is not necessary to have an additional protection film adhesion table, camera, or the like, thereby reducing the fabrication cost as well as simplifying the fabrication line.

In the cutting line 166, the mother substrate 100 is cut in a unit of the panel region 101 and divided into a plurality of unit display panels. At this time, a cutting wheel is provided in the 166 and a predetermined cutting line is formed, and then a pressure is applied by a pressure bar in order to divide the predetermined cutting line. Furthermore, the mother substrate 100 may be dissolved by using a laser to cut the mother substrate 100.

For the divided unit display panel as described above, bubbles included in the electronic ink film or protection film are removed by an air removal device, and then inspected whether any defect is found in the unit display panel by various inspections such as visual inspection or lighting inspection. If there is no defect in the foregoing inspections, then a seal material is coated on the outer-wall region thereof and then exposed to heat or light on a curing table in order to cure the seal material. Subsequently, the display panel is sealed and accommodated in a lower or upper case thereof, thereby finishing an electrophoretic display device.

As described above, processes such as a formation of thin-film transistors and various wirings, an adhesion of a FPL film, and an adhesion of a protection film are performed in a mother substrate unit, because the FPL film and protection film are adhered to a plurality of panel regions formed on a mother substrate. In a method of fabricating an electrophoretic display device in the related art, in which a mother substrate is cut and then a FPL film and a protection film are adhered to the divided electrophoretic display device, a thin-film transistor array process is performed on a mother substrate, and then subsequent processes should be performed for a plurality of the divided display panels respectively, and therefore, some of the plurality of the divided display panels should be stored while others being transferred to subsequent processes, thereby making it impossible to automate an overall line. On the contrary, according to the present invention, an overall process is performed in a mother substrate unit, and therefore, if one process is completed, then the relevant mother substrate is transferred to a subsequent process line by a transfer means such as conveyer belt to perform the relevant process, thereby making it possible to automate an overall line. As a result, according to the present invention, the process may be performed quickly due to the automation, and thus it may be possible to manage the process with the minimum number of persons.

On the other hand, though an adhesion table or electrophoretic display device is described by limiting it to a particular structure as disclosed above, a fabrication line and fabrication method of an electrophoretic display device according to the present invention is not limited to such a particular structure. For example, the present invention will be also applicable to an electrophoretic display device provided with a color filter to implement colors, an electrophoretic display device provided with a separate reflection plate, or the like. Furthermore, it may be also applicable to various types of adhesion tables. In other words, the present invention is not limited to a fabrication line with a particular structure, but will be applicable to all fabrication lines or fabrication methods in which the process is performed in a mother substrate unit to automate an entire fabrication line thereof.

As described above, although preferred embodiments of the present invention have been described, it should be understood by those skilled in the art that various modifications and equivalent other embodiments of the present invention can be made.

Accordingly, it should be noted that the scope of the right of the present invention is not limited by those embodiments, and various modifications and improvements made without departing from the spirit of the invention and within the scope of the appended claims are also included in the scope of the right of the present invention.

What is claimed is:

1. A fabrication line of an electrophoretic display device, comprising:
a thin-film transistor array line for forming thin-film transistors on a mother substrate having a plurality of panel regions;
an electronic ink line for forming a common electrode on a transparent sheet and adhering an electronic ink film to the common electrode to form a front plane laminate (FPL) film;
an adhesion line for adhering a FPL film to the plurality of panel regions on a mother substrate by loading the mother substrate and the FPL film from the thin-film transistor array line and the electronic ink line, respectively; and
a protection film adhesion line for adhering a protection film on the plurality of panel regions by loading a mother substrate adhered with a FPL film from the adhesion line,
wherein the panel regions are arranged in a matrix with M columns and N rows (M and N are greater than or equal to 2) on the mother substrate, and N or M robot arms are provided to adhere FPL films and protection films to the plurality of panel regions formed on the mother substrate in a column or row unit.

2. The fabrication line of an electrophoretic display device of claim 1, wherein the adhesion line comprises,
an adhesion table on which a mother substrate is loaded;
at least one camera provided on an upper portion of the adhesion table to align the mother substrate with a FPL film; and
at least one robot arm for loading a FPL film on the mother substrate adhered to the adhesion table.

3. The fabrication line of an electrophoretic display device of claim 1, wherein the protection film adhesion line comprises,
an adhesion table on which a mother substrate is loaded;
at least one camera provided on an upper portion of the adhesion table to align the mother substrate with a FPL film; and
at least one robot arm for loading a FPL film on the mother substrate adhered to the adhesion table.

4. The fabrication line of an electrophoretic display device of claim 2, wherein the protection film is adhered to a mother substrate on the adhesion table.

5. The fabrication line of an electrophoretic display device of claim 2, wherein N or M cameras are provided to perform an alignment of a plurality of panel regions formed on a mother substrate.

6. The fabrication line of an electrophoretic display device of claim 1, further comprising:
a conveyer belt disposed between each of the process lines to transfer a mother substrate to the subsequent process line.

7. The fabrication line of an electrophoretic display device of claim 1, further comprising:
a buffer disposed between each of the process lines to synchronize between a process line and a subsequent process line.

8. The fabrication line of an electrophoretic display device of claim 1, further comprising:
a cutting line for cutting a mother substrate loaded from the protection film adhesion line and dividing into an electrophoretic display panel unit.

9. A fabrication method of an electrophoretic display device, the method comprising:
forming thin-film transistors on a mother substrate having a plurality of panel regions;
forming a common electrode on a transparent sheet and adhering an electronic ink film on the common electrode to form a front plane laminate (FPL) film;
adhering a FPL film on each of the plurality of panel regions formed on a mother substrate; and
adhering a protection film on each of the plurality of panel regions on the mother substrate adhered with the FPL film,
wherein the panel regions are arranged in a matrix with M columns and N rows (M and N are greater than or equal to 2) on the mother substrate to adhere FPL films and protection films in a column or row unit.

10. The fabrication method of an electrophoretic display device of claim 9, further comprising:
cleaning a mother substrate formed with the thin-film transistors; and
removing bubbles in the mother substrate adhered with a protection film.

11. The fabrication method of an electrophoretic display device of claim 9, further comprising:
forming an Ag dot in each of the plurality of panel regions of the mother substrate prior to adhering a transparent sheet.

12. The fabrication method of an electrophoretic display device of claim 9, further comprising:
inspecting divided electrophoretic display devices;
coating a seal material on the divided electrophoretic display devices; and
curing the seal material on the divided electrophoretic display devices.
